(19) United States
(12) Patent Application Publication
(10) Pub. No.: US 2023/0185668 A1
(43) Pub. Date: Jun. 15, 2023

(54) ON-PREMISES TO CLOUD MIGRATION OF ENDPOINT PERFORMANCE MONITORING

(71) Applicant: VMWARE, INC., Palo Alto, CA (US)

(72) Inventors: VINOTHKUMAR D., Villupuram (IN); Rahul Singh, Ramnagar (IN); Vineeth Totappanavar, Bangalore (IN); Padmini Sampige Thirumalachar, Bangalore (IN); Akansha Srivastava, Bangalore (IN)

(21) Appl. No.: 17/549,942

(22) Filed: Dec. 14, 2021

(51) Int. Cl. G06F 11/14; G06F 9/455; G06F 9/4401

(52) U.S. Cl. CPC G06F 11/1433; G06F 11/1484; G06F 9/45558; G06F 9/4406; G06F 2009/45575; G06F 2009/45591

(57) ABSTRACT

A method to upgrade an on-premises based first remote collector to a cloud-based second remote collector is described. In an example, an operating system of a virtual appliance that runs the first remote collector is upgraded. The first remote collector may monitor an endpoint and send monitored information to a first monitoring application running on an on-premises server. Further, a second remote collector associated with a second monitoring application is installed on the virtual appliance. The second monitoring application runs on a cloud-based server. Furthermore, connection information of the second remote collector is configured to connect to the second monitoring application. Then, the first remote collector is upgraded to the second remote collector using the upgraded operating system and the connection information. Upon rebooting the virtual appliance, the second remote collector can be enabled to monitor the endpoint and send monitored information to the second monitoring application.

### TECHNICAL FIELD

The present disclosure relates to computing environments, and more particularly to methods, techniques, and systems for migrating application performance monitoring from an on-premises platform to a cloud platform (e.g., a Software as a service (SaaS) platform).

### BACKGROUND

In application/operating system (OS) monitoring environments, a management node that runs a monitoring tool may communicate with multiple endpoints to monitor the endpoints. For example, an endpoint may be implemented in a physical computing environment, a virtual computing environment, or a cloud computing environment. Further, the endpoints may execute different applications via virtual machines (VMs), physical host computing systems, containers, and the like. In such environments, the management node may communicate with the endpoints to collect performance data/metrics (e.g., application metrics, operating system metrics, and the like) from underlying operating system and/or services on the endpoints for storage and performance analysis (e.g., to detect and diagnose issues).

### BRIEF DESCRIPTION OF THE DRAWINGS

FIG. 1 is a block diagram of an example system, depicting a management node to upgrade a first remote collector that communicates with an on-premises' based monitoring application to a second remote collector that communicates with a cloud-based monitoring application;

FIG. 2A is a sequence diagram illustrating a sequence of events to migrate application performance monitoring from an on-premises platform to a cloud platform;

FIG. 2B shows an example data center, depicting upgrading of an application remote collector (ARC) to a cloud proxy to migrate application performance monitoring from the on-premises platform to the cloud platform;

FIG. 3 is a flow diagram, illustrating an example method for upgrading a first remote collector that communicates with an on-premises' based monitoring application to a second remote collector that communicates with a cloud-based monitoring application; and

FIG. 4 is a block diagram of an example management node including non-transitory computer-readable storage medium storing instructions to transform a first remote collector to a second remote collector in a data center.

The drawings described herein are for illustration purposes and are not intended to limit the scope of the present subject matter in any way.

### DETAILED DESCRIPTION

Examples described herein may provide an enhanced computer-based and/or network-based method, technique, and system to upgrade a remote collector that communicates with an on-premises' based monitoring application to communicate with a cloud-based monitoring application in a computing environment. Computing environment may be a physical computing environment (e.g., an on-premises enterprise computing environment or a physical data center) and/or virtual computing environment (e.g., a cloud computing environment, a virtualized environment, and the like).

The virtual computing environment may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in a virtual space being hosted by one or more physical data centers. The virtual computing environment may include multiple physical computers executing different workloads (e.g., virtual machines, containers, and the like). Such workloads may execute different types of applications.

Further, performance monitoring of endpoints (e.g., physical host computing systems, virtual machines, software defined data centers (SDDCs), containers, and/or the like) has become increasingly important because performance monitoring may aid in troubleshooting (e.g., to rectify abnormalities or shortcomings, if any) the endpoints, provide better health of data centers, analyse the cost, capacity, and/or the like. An example performance monitoring tool or application or platform may be VMware® vRealize Operations (vROps), Vmware Wavefront™, Grafana, and the like.

Further, the endpoints may include monitoring agents (e.g., Telegraf™, collectd, Micrometer, and the like) to collect the performance metrics from the respective endpoints and provide, via a network, the collected performance metrics to a remote collector. Furthermore, the remote collector may receive the performance metrics from the monitoring agents and transmit the performance metrics to the monitoring tool for metric analysis. A remote collector may refer to a service/program that is installed in an additional cluster node (e.g., a virtual machine). The remote collector may allow the monitoring tool (e.g., vROps Manager) to gather objects into the remote collector's inventory for monitoring purposes. The remote collectors collect the data from the endpoints and then forward the data to the management node that executes the monitoring tool. For example, remote collectors may be deployed at remote location sites while the monitoring tool may be deployed at a primary location.

Furthermore, the monitoring tool may receive the performance metrics, analyse the received performance metrics, and display the analysis in a form of dashboards, for instance. The displayed analysis may facilitate in visualizing the performance metrics and diagnose a root cause of issues, if any.

In some computing environments, the monitoring tools (e.g., vROps) may be deployed and run in on-premises platform to collect data from the endpoints via the remote collectors. The term “on-premises” may refer to a software and a hardware infrastructural setup (e.g., associated with the monitoring tools) deployed and running from within the confines of an organization/enterprise. In some other computing environments, the monitoring tools (e.g., vROps) may be deployed and run-in cloud platforms (e.g., Software as a service (SaaS) platforms) to collect data from the endpoints via cloud proxies (CPs). SaaS is a software distribution model in which a cloud provider hosts applications and makes the applications available to end users over the Internet. Cloud computing and Software as a service (SaaS) offers a plethora of advantages over the on-premises environment, viz. replacing capital expenditures with operating expenses, no upfront costs, subscription-based pricing, and the like.

The Cloud computing and SaaS have changed software consumption, software development, and support processes. This is due to the fact that in a SaaS model the software applications (e.g., the monitoring tools) are hosted by a service provider and/or a vendor and may not be deployed on customer's premises. This specific delivery model may be considered as an enabler for a different approach to software development and support users. Hence, customers may have to be provided with a hassle-free approach of application performance monitoring migration from the on-premises platform to the SaaS platform.

In an example on-premises platform, an application remote collector (ARC) is a type of remote collector that the monitoring tool (e.g., vROps) uses to collect metrics of applications running on endpoints (e.g., virtual machines) using monitoring agents. In an example SaaS platform, a cloud proxy is a type of remote collector that the monitoring tool (e.g., vROps) uses to collect metrics of applications running on endpoints (e.g., virtual machines) using monitoring agents. However, the ARC and cloud proxy are two different virtual appliances running on different versions of operating systems (e.g., Photon Operating Systems). For example, the ARC may run on Photon operating system version 1.0 whereas the cloud proxy may run on Photon operating system version 3.0. Further, components such as file server, data plane, and message receivers are different in both the virtual appliances. Also, hardware configurations can be different for both the virtual appliances. For example, the ARC may need a hardware configuration of 4 GB for processing capacity and 40 GB for storage capacity and the cloud proxy may need a hardware configuration of 2 GB for processing capacity and 84 GB for storage capacity.

An existing method to migrate the performance monitoring from the on-premises platform to the cloud platform may include a “start from scratch” approach, where both the remote collector and the monitoring agents on the endpoints (e.g., virtual machines) undergo a fresh/new installation. However, this approach may result in a potential loss of historical data that can occur due to fresh installation of the monitoring agents. This approach may also result in a downtime in monitoring incurred to perform the fresh installation of the remote collector and the monitoring agents.

Another existing method to migrate the performance monitoring from the on-premises platform to the cloud platform may include ‘start from half-way’ approach, where certificates and keys of certificate authority (CA) and endpoint virtual machines (VMs) of old ARC are copied to the new cloud proxy. Additionally, monitoring agents are updated to send the metrics to the new cloud proxy. However, this approach may involve manual effort to copy the keys and certificates. Further, this approach may involve manual effort to ascertain that the certificates and keys have been copied without any errors, hence an audit trail mechanism may have to be in place. In some examples, the users are wary of providing the Secure Socket Shell (SSH) credentials and may need to get permissions from a different organization. Hence, this approach may not provide a seamless experience to the customer. Also, updating endpoint virtual machines' control channel may result in quasi state which may not be recoverable. Thus, in both the approaches, the need for additional virtual machine/hardware to start with can be an added burden.

Examples described herein may provide a management node to seamlessly migrate the performance monitoring from the on-premises platform to the cloud platform (e.g., a SaaS platform). The management node may provision an additional storage resource to a virtual appliance that runs a first remote collector (e.g., an ARC). The first remote collector may communicate with an endpoint (e.g., VM) and a first monitoring application (e.g., vROps) running on an on-premises server. Further, the management node may upgrade an operating system of the virtual appliance. Furthermore, the management node may install a second remote collector (e.g., a cloud proxy) associated with a second monitoring application on the virtual appliance. The second monitoring application runs on a cloud-based server. Further, the management node may configure connection information of the second remote collector to connect to the second monitoring application. Also, the management node may transform the first remote collector to the second remote collector using the additional storage resource, upgraded operating system, and the connection information. Then, the management node may either reboot the virtual appliance or prompt to reboot the virtual appliance. Upon reboot of the virtual appliance, the second remote collector may be enabled to monitor the endpoint and send the monitored information to the second monitoring application.

Examples described herein may not involve a manual effort such as copying certificates and keys from the ARC to the cloud proxy, manual re-installation of the monitoring agents, or the like. Further, adverse impact on application availability metrics would be minimal (e.g., as the control plane connectivity stays intact). Furthermore, failover rate for migration of the performance monitoring from the on-premises platform to the cloud platform can be significantly reduced. Endpoint virtual machines can be in a stable state, i.e., the virtual machines are updated and recoverable and may not be stuck in a quasi-state. Also, the customer may have a seamless experience to migrate the performance monitoring from the on-premises platform to the cloud platform using a known and established path of upgrade, for instance, vCenter Server Appliance Management Interface (VAMI), and hence may not require a new learning effort from the user perspective.

In the following description, for purposes of explanation, numerous specific details are set forth to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described is included in at least that one example, but not necessarily in other examples.

### System Overview and Examples of Operation

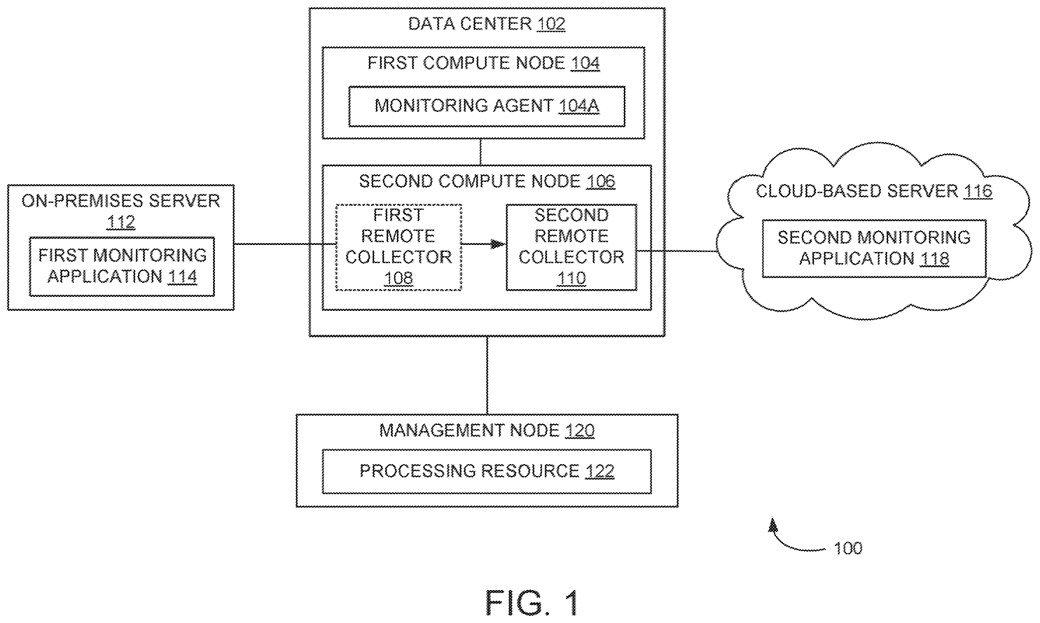

FIG. 1 is a block diagram of an example system 100, depicting a management node 120 to upgrade a first remote collector 108 that communicates with an on-premises' based monitoring application to a second remote collector 110 that communicates with a cloud-based monitoring application. Example system 100 may include a computing environment such as a cloud computing environment (e.g., a virtualized cloud computing environment), a physical computing environment, or a combination thereof. For example, the cloud computing environment may be VMware vSphere®. The cloud computing environment may include one or more computing platforms that support the creation, deployment, and management of virtual machine-based cloud applications. An application, also referred to as an application program, may be a computer software package that performs a specific function directly for an end user or, in some cases, for another application. Examples of applications may include MySQL, Tomcat, Apache, word processors, database programs, web browsers, development tools, image editors, communication platforms, and the like.

As shown in FIG. 1, example system 100 may include a data center 102 having multiple compute nodes (e.g., a first compute node 104 and a second compute node 106). In an example, first compute node 104 may include, but not limited to, a virtual machine, a physical host computing system, a container, a software defined data center (SDDC), or any other computing instance that executes different applications. For example, first compute node 104 can be deployed either in an on-premises platform or an off-premises platform (e.g., a cloud managed SDDC). An SDDC may refer to a data center where infrastructure is virtualized through abstraction, resource pooling, and automation to deliver Infrastructure-as-a-service (IAAS). Further, the SDDC may include various components such as a host computing system, a virtual machine, a container, or any combinations thereof. Example host computing system may be a physical computer. The physical computer may be a hardware-based device (e.g., a personal computer, a laptop, or the like) including an operating system (OS). The virtual machine may operate with its own guest operating system on the physical computer using resources of the physical computer virtualized by virtualization software (e.g., a hypervisor, a virtual machine monitor, and the like). The container may be a data computer node that runs on top of host operating system without the need for the hypervisor or separate operating system.

Further, example system 100 may include management node 120 to manage data center 102. For example, management node 120 may execute centralized management services that may be interconnected to manage the resources centrally in the virtualized computing environment. Example centralized management service may be a part of vCenter Server™ and vSphere® program products, which are commercially available from Vmware.

Further, first compute node 104 may include a monitoring agent 104A to monitor first compute node 104. In an example, monitoring agent 104A may be installed in first compute node 104 to fetch the metrics from various components of first compute node 104. For example, monitoring agent 104A may real-time monitor first compute node 104 to collect the metrics (e.g., telemetry data) associated with an application or an operating system running in first compute node 104. Example monitoring agent 104A may include Telegraf agent, Collectd agent, or the like. Example metrics may include performance metric values associated with at least one of central processing unit (CPU), memory, storage, graphics, network traffic, or the like.

Furthermore, second compute node 106 may execute first remote collector 108 that communicates with first compute node 104. During operation, first remote collector 108 may receive the metrics (e.g., performance metrics) from monitoring agent 104A of first compute node 104. Further, first remote collector 108 may transmit the metrics to a first monitoring application 114 running on an on-premises server 112. For example, second compute node 106 may be a physical host computing system, a virtual machine, or the like. Second compute node 106 may receive the metrics from monitoring agent 104A and ingest the metrics to first monitoring application 114. In an example, first remote collector 108 may allow first monitoring application 114 to gather the metrics for monitoring purposes.

In an example, management node 120 may be communicatively connected to data center 102 via a network to manage data center 102. An example network can be a managed Internet protocol (IP) network administered by a service provider. For example, the network may be implemented using wireless protocols and technologies, such as Wi-Fi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Further, management node 120 may include a processing resource 122. Processing resource 122 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processing resource 122 may, for example, include single or multiple cores on a chip, multiple cores across multiple chips, multiple cores across multiple devices, or suitable combinations thereof. Processing resource 122 may be functional to fetch, decode, and execute instructions as described herein.

During operation, processing resource 122 may receive a request to migrate endpoint performance monitoring from an on-premises platform to a cloud platform. To migrate the endpoint performance monitoring from the on-premises platform to the cloud platform, first remote collector 108 that communicates with on-premises' based monitoring application (i.e., first monitoring application 114) has to be upgraded or transformed to second remote collector 110 that communicates with a cloud-based monitoring application (i.e., a second monitoring application 118).

To upgrade or transform first remote collector 108 (e.g., an application remote collector (ARC)) to second remote collector 110 (e.g., a cloud proxy), processing resource 122 may upgrade a hardware configuration (e.g., a storage resource) and an operating system of second compute node 106. In an example, processing resource 122 may deploy an operating system upgrade package associated with a second version of the operating system on second compute node 106. Further, processing resource 122 may upgrade the operating system of second compute node 106 from a first version that supports first remote collector 108 to the second version that supports second remote collector 110 according to the operating system upgrade package. The operating system of second compute node 106 may be upgraded from the first version to the second version without hopping on intermediate versions.

In an example, second remote collector 110 acts as a cloud proxy for first compute node 104 to communicate with second monitoring application 118 running in a cloud-based server 116. Example second monitoring application 118 is a SaaS application. Further, processing resource 122 may install second remote collector 110 on second compute node 106.

Further, processing resource 122 may configure connection information of second remote collector 110 to connect to second monitoring application 118. In an example, processing resource 122 may generate a one-time key during the installation of second remote collector 110 on second compute node 106.

Furthermore, processing resource 122 may upgrade first remote collector 108 to second remote collector 110 using the upgraded hardware configuration, upgraded operating system, and the connection information. In an example, processing resource 122 may upgrade first remote collector 108 to second remote collector 110 by:
uninstalling and deleting an installation package associated with first remote collector 108, and
installing an installation package associated with second remote collector 110 upon deleting the installation package associated with first remote collector 108.

Furthermore, processing resource 122 may reboot second compute node 106 to enable second remote collector 110 to communicate with first compute node 104 and second monitoring application 118. Thus, upon rebooting second compute node 106, a secure communication may be established between second remote collector 110 and second monitoring application 118 based on the one-time key. In an example, processing resource 122 may:
download a boot image and a boot program associated with second remote collector 110 to second compute node 106, and
reboot second compute node 106 using the boot image and a boot program associated with second remote collector 110. Upon reboot of second compute node 106, processing resource 122 may update configuration information of monitoring agent 104A running in first compute node 104 to communicate with second remote collector 110 to transmit the performance metrics and to receive a control command.

In an example, second remote collector 110 may collect performance metrics of the operating system and/or applications associated with first compute node 104 in runtime. Further, second remote collector 110 may transmit the performance metrics to second monitoring application 118 via the network for monitoring and troubleshooting the first compute node 104.

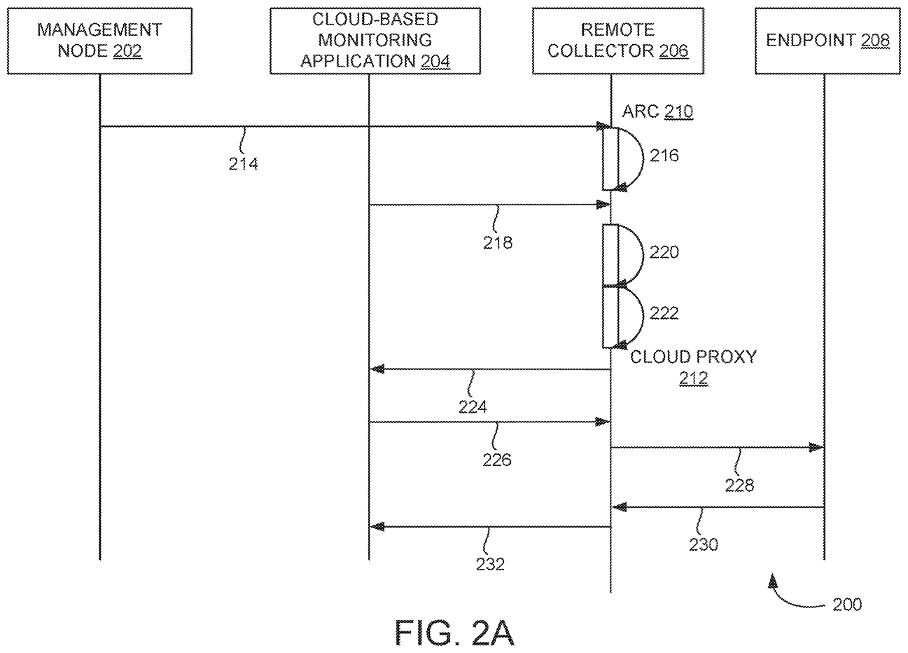

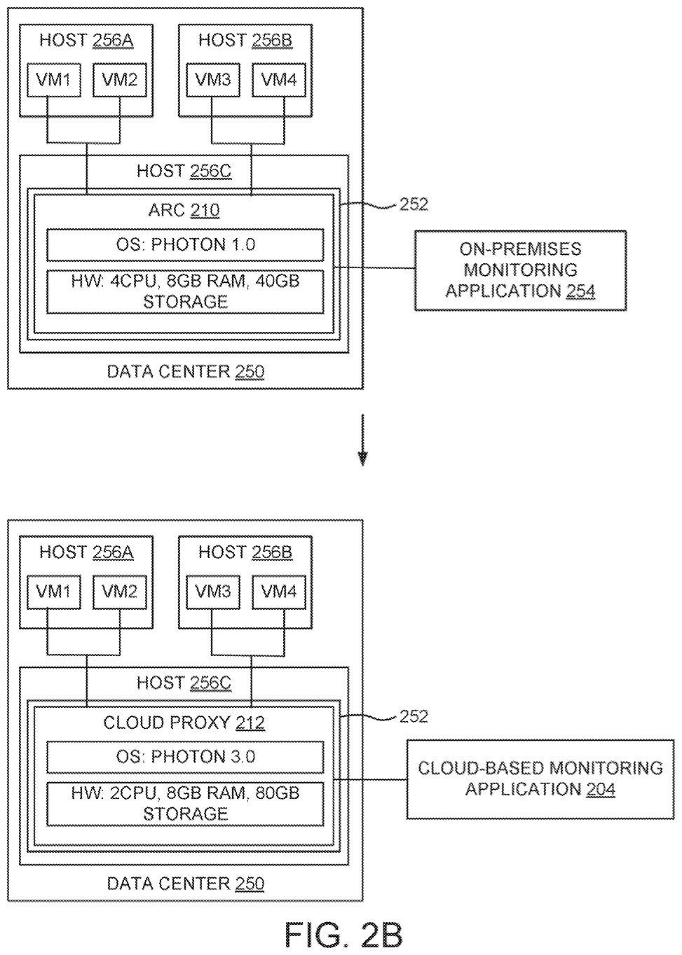

FIG. 2A is a sequence diagram illustrating a sequence of events to migrate application performance monitoring from an on-premises platform to a cloud platform (e.g., a Software as a service (SaaS) platform). The sequence diagram may represent the interactions and the operations involved in upgrading a remote collector 206 to migrate application performance monitoring from the on-premises platform to the cloud platform. FIG. 2A illustrates process objects including a management node 202, a cloud-based monitoring application 204, remote collector 206, and an endpoint 208 along with their respective vertical lines originating from them. The vertical lines of management node 202, cloud-based monitoring application 204, remote collector 206, and endpoint 208 may represent the processes that may exist simultaneously. The horizontal arrows (e.g., 214, 218, 224, 226, 228, 230, and 232) may represent the process/sequence flow steps between the vertical lines originating from their respective process objects (for e.g., management node 202, cloud-based monitoring application 204, remote collector 206, and endpoint 208). Further, activation boxes (e.g., 216, 220, and 222) between the horizontal arrows may represent the process that is being performed in the respective process object.

In the example shown in FIG. 2B, a virtual machine VM1, VM2, VM3, or VM4 (i.e., endpoint 208 as shown in FIG. 2A) may run on a respective host computing system 256A or 256B. An example host computing system 256A or 256B is an enterprise-class type-1 (ESXi) hypervisor executing multiple virtual machines. Further, remote collector 206 may communicate with endpoint 208 to collect performance metrics and transmit the metrics to an on-premises-based monitoring application (e.g., vROps) for analysis. In an example, remote collector 206 may be an application remote collector (ARC) 210. Example management node 202 (e.g., vCenter) may upgrade ARC 210 to a second remote collector, e.g., a cloud proxy 212, to migrate application performance monitoring from the on-premises platform to the cloud platform (e.g., as shown in 214, 216, 218, 220, 222, 224, 226, 228, 230, and 232).

At 214, an additional storage resource may be provisioned to a virtual appliance that executes ARC 210. FIG. 2B shows an example data center 250 depicting upgrading of ARC 210 to cloud proxy 212 to migrate application performance monitoring from the on-premises platform to the cloud platform. As shown in FIG. 2B, ARC 210 may run in a virtual appliance 252. An example virtual appliance 252 is a virtual machine running on a host computing system 256C. In this example, the additional storage resource may be provisioned to virtual appliance 252 from host computing system 256C. In the example shown in FIG. 2B, to migrate ARC 210 to cloud proxy 212, resource specification of virtual appliance 252 may be considered. For example, the resource specification for ARC 210 and required resource specification to install cloud proxy 212 is shown in below Table 1.

TABLE 1

| Resource | ARC | Cloud Proxy |
|---|---|---|
| vCPU | 4 | 2 |
| Memory | 8 GB | 8 GB |
| Hard Disk | 40 GB (30 + 10) | 84 GB (20 + 60 + 4) |

As shown in table 1, virtual appliance 252 may require additional 44 GB of hard disk with specified partitions (e.g., 20+60+4). Thus, additional 44 GB may be provisioned to virtual appliance 252.

Referring back to FIG. 2A, at 216, an operating system of the virtual appliance may be upgraded. Referring to FIG. 2B, an operating system upgrade package associated with a second version of the operating system may be deployed on virtual appliance 252. Further, the operating system of virtual appliance 252 may be upgraded from a first version that supports ARC 210 to the second version that supports cloud proxy 212 according to the operating system upgrade package.

For example, each version of the operating system may include multiple dependency packages to carry out operating system functionalities and user applications. Further, the versions of such packages may be upgraded for security reasons or for new features. In some examples, providers of the operation system may recommend upgrading the operating system from a current version to a next version and not to hop directly to the latest version to ease maintenance of a release version and to avoid package management issues. Since package management of each operating system version is independent, there may be a chance that a version of some packages in older operating system version may be greater than that of a latest operating system version.

In the example shown in FIG. 2B, ARC 210 runs on Photon operating system 1.0 and cloud proxy 212 runs on Photon operating system 3.0. On upgrading Photon operating system from 1.0 to 3.0 without hopping on intermediate version (2.0), afore mentioned package version issue may be considered. For example, the version of glib and dbus packages on 1.0 may be greater than the version of glib and dbus packages on 3.0. The operating system upgrade package described above may facilitate to apply changes on existing versions and not to be tested for dependency.

At 218, connection information of remote collector 206 may be configured. In the example of FIG. 2B, connection information may include a one-time key generated during the installation of cloud proxy 212 on virtual appliance 252. With the connection information, upon rebooting virtual appliance 252, a secure communication may be established between cloud proxy 212 and cloud-based monitoring application 204 based on the one-time key. For example, cloud proxy 212 may be capable of connecting to cloud-based monitoring application 204 based on the one-time key set during the installation of cloud proxy 212. In an example, the one-time key may be manually set on virtual appliance 252.

At 220, remote collector 206 may be upgraded to cloud proxy 212 using the upgraded hardware configuration, upgraded operating system, and the connection information. In the example of FIG. 2B, ARC 210 may be upgraded to cloud proxy 212 using an administration web interface such as vCenter server appliance management interface (VAMI). The VAMI may update virtual appliance 252 to the build (e.g., upgraded hardware configuration, upgraded operating system, and the connection information) provided. For example, the VAMI may first update the operating system, then operating system packages, and user packages. Further, components (e.g., Salt, EMQTT, Nginx, UCPAPI server, and the like) associated with ARC 210 may be packaged as a red hat package (RPM) package and installed on virtual appliance 252. Components (e.g., Salt, Apache, libraries, and the like) associated with cloud proxy 212 may be packaged as RPM package. Further, to upgrade ARC 210 to cloud proxy 212, the ARC RPM package may be uninstalled and cleared. Further, cloud proxy RPM package may be installed to have files and components of cloud proxy 212 in virtual appliance 252. Also, cloud proxy contents and boot scripts (e.g., cloud proxy iso) may be downloaded and mounted.

At 222, the virtual appliance may be rebooted to enable cloud proxy 212 to communicate with endpoint 208 and cloud-based monitoring application 204. In the example of FIG. 2B, upgrading ARC 210 using the VAMI may install/upgrade the files and directories on virtual appliance 252. The updated files may be stored on disk of virtual appliance 252. Further, to choose the updated files and components of cloud proxy 212, processes in virtual appliance 252 may be restarted. Restarting virtual appliance 252 may load the updated files from a secondary storage to a main memory and use for execution. In an example, a user may be prompted to reboot virtual appliance 252. In another example, virtual appliance 252 may be dynamically rebooted after upgrading from ARC 210 to cloud proxy 212. Also, since the additional storage resource is provisioned in virtual appliance 252, when virtual appliance 252 is rebooted, cloud proxy 212 may be selected for execution.

At 224, cloud proxy 212 may communicate with cloud-based monitoring application 204 upon rebooting virtual appliance 252. At 226, cloud-based monitoring application 204 may instruct cloud proxy 212 to initiate an update configuration of monitoring agent in endpoint 208. At 228, a monitoring agent in endpoint 208 may be updated. For example, due to changes in server components like data plane (e.g., EMQTT→HTTPD), file server (e.g., NGINX→HTTPD), and API servers (e.g., REST API→Internal library), configuration changes and services may be updated at endpoint 208 that is to be monitored. In this example, the configurations such as a file server port, message listener plugins (e.g., MQTT→HTTPD) may be updated and telegraf service may be restarted to post metrics to cloud proxy 212, which may update a time series data base for storing the metrics.

At 230, cloud proxy 212 may collect the metrics from endpoint 208 and transmit the metrics to cloud-based monitoring application 204, at 232. Thus, examples described herein may reduce the burden of manual interventions or reinstall of agents to migrate application performance monitoring from an on-premises platform (e.g., an on-premises monitoring application 254 of FIG. 2B) to a cloud platform (e.g., cloud-based monitoring application 204, i.e., SaaS application).

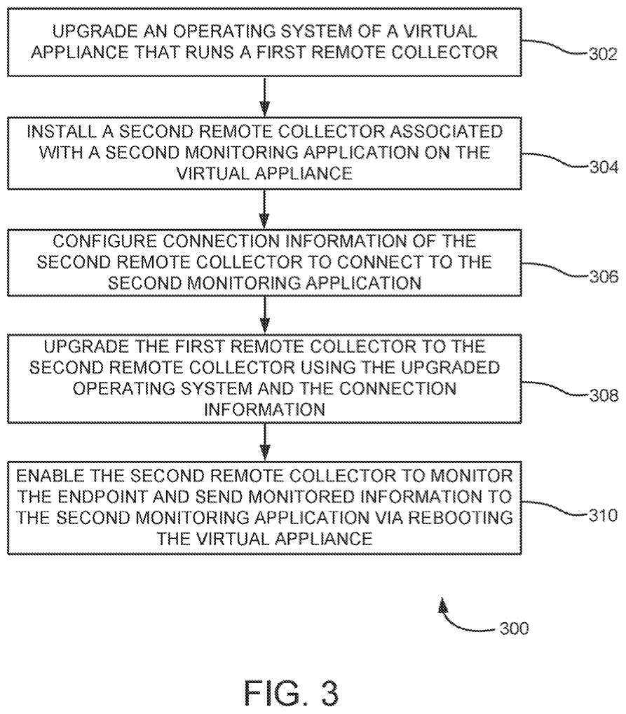

FIG. 3 is a flow diagram 300, illustrating an example method for upgrading a first remote collector that communicates with an on-premises' based monitoring application to a second remote collector that communicates with a cloud-based monitoring application. The process depicted in FIG. 3 represents generalized illustrations, and that other processes may be added, or existing processes may be removed, modified, or rearranged without departing from the scope and spirit of the present application. In addition, the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 302, an operating system of a virtual appliance that runs a first remote collector may be upgraded. For example, the first remote collector may monitor an endpoint and send monitored information to a first monitoring application running on an on-premises server. In an example, upgrading the operating system of the virtual appliance may include:
deploying an operating system upgrade package associated with a second version of the operating system on the virtual appliance; and
upgrading the operating system of the virtual appliance from a first version that supports the first remote collector to the second version that supports the second remote collector according to the operating system upgrade package.

At 304, upon upgrading the operating system, a second remote collector associated with a second monitoring application may be installed on the virtual appliance. In an example, the second monitoring application may run on a cloud-based server. For example, the second remote collector may act as a cloud proxy to communicate with the second monitoring application running in the cloud-based server. In an example, installing the second remote collector associated with the second monitoring application on the virtual appliance may include:
upgrading a hardware configuration of the virtual appliance that runs the first remote collector based on a hardware requirement of the second remote collector, and
installing the second remote collector associated with the second monitoring application on the virtual appliance upon upgrading the operating system and the hardware configuration.

At 306, connection information of the second remote collector may be configured to connect to the second monitoring application. In an example, configuring the connection information of the second remote collector may include generating a one-time key during the installation of the second remote collector on the virtual appliance. For example, upon rebooting the virtual appliance, a secure communication may be established between the second remote collector and the second monitoring application based on the one-time key.

At 308, the first remote collector may be upgraded to the second remote collector using the upgraded operating system and the connection information. At 310, the second remote collector may be enabled to monitor the endpoint and send monitored information to the second monitoring application via rebooting the virtual appliance. In an example, configuration information of a monitoring agent running in the endpoint may be updated to communicate with the second remote collector to transmit the performance metrics and to receive a control command.

Further, performance metrics of the operating system and/or applications associated with the endpoint may be collected by the second remote collector in runtime. Furthermore, the performance metrics may be transmitted to the second monitoring application via a network for monitoring and troubleshooting the endpoint. In an example, the performance metrics may be received by the second monitoring application from the second remote collector via the network. Further, a performance analysis of the endpoint may be performed by the second monitoring application using the received performance metrics.

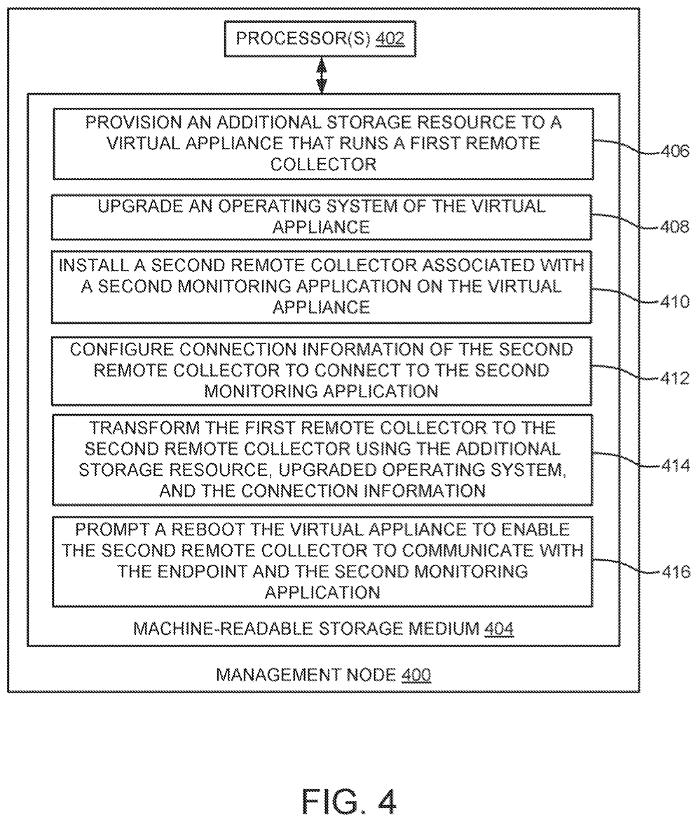

FIG. 4 is a block diagram of an example management node 400 including non-transitory computer-readable storage medium 404 storing instructions to transform a first remote collector to a second remote collector in a data center. Management node 400 may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to management node 400.

Machine-readable storage medium 404 may store instructions 406, 408, 410, 412, 414, and 416. Instructions 406 may be executed by processor 402 to provision an additional storage resource to a virtual appliance that runs a first remote collector. In an example, the first remote collector may communicate with an endpoint. For example, the endpoint may be a physical host computing system, a virtual machine, a container, or a software defined data center (SDDC). Further, a first monitoring application may run on an on-premises server.

Instructions 408 may be executed by processor 402 to upgrade an operating system of the virtual appliance. Instructions 410 may be executed by processor 402 to install a second remote collector associated with a second monitoring application on the virtual appliance. In an example, the second monitoring application may run on a cloud-based server. For example, the second remote collector acts as a cloud proxy for the endpoint to communicate with the second monitoring application running in the cloud-based server.

Instructions 412 may be executed by processor 402 to configure connection information of the second remote collector to connect to the second monitoring application. Instructions 414 may be executed by processor 402 to transform the first remote collector to the second remote collector using the additional storage resource, upgraded operating system, and the connection information. In an example, instructions to transform the first remote collector to the second remote collector may include instructions to:
uninstall and delete an installation package associated with the first remote collector from the virtual appliance, and
install an installation package associated with the second remote collector on the virtual appliance upon deleting the installation package associated with the first remote collector.

Instructions 416 may be executed by processor 402 to prompt a reboot the virtual appliance to enable the second remote collector to communicate with the endpoint and the second monitoring application.

Machine-readable storage medium 404 may further store instructions to be executed by processor 402 to update configuration information of a monitoring agent running in the virtual appliance to communicate with the second remote collector to transmit the performance metrics and to receive a control command upon reboot of the virtual appliance.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A method comprising:
upgrading an operating system of a virtual appliance that runs a first remote collector, wherein the first remote collector is to monitor an endpoint and send monitored information to a first monitoring application running on an on-premises server;
upon upgrading the operating system, installing a second remote collector associated with a second monitoring application on the virtual appliance, wherein the second monitoring application is to run on a cloud-based server;
configuring connection information of the second remote collector to connect to the second monitoring application;
upgrading the first remote collector to the second remote collector using the upgraded operating system and the connection information; and
enabling the second remote collector to monitor the endpoint and send monitored information to the second monitoring application via rebooting the virtual appliance.

2. The method of claim 1, wherein upgrading the operating system of the virtual appliance comprises:
deploying an operating system upgrade package associated with a second version of the operating system on the virtual appliance; and
upgrading the operating system of the virtual appliance from a first version that supports the first remote collector to the second version that supports the second remote collector according to the operating system upgrade package.

3. The method of claim 1, further comprising:
collecting, by the second remote collector, performance metrics of the operating system and/or applications associated with the endpoint in runtime; and
transmitting, via a network, the performance metrics to the second monitoring application for monitoring and troubleshooting the endpoint.

4. The method of claim 3, further comprising:
receiving, by the second monitoring application, the performance metrics from the second remote collector via the network; and
performing, by the second monitoring application, a performance analysis of the endpoint using the received performance metrics.

5. The method of claim 1, wherein the second remote collector acts as a cloud proxy to communicate with the second monitoring application running in the cloud-based server.

6. The method of claim 1, further comprising:
updating configuration information of a monitoring agent running in the endpoint to communicate with the second remote collector to transmit the performance metrics and to receive a control command.

7. The method of claim 1, wherein installing the second remote collector associated with the second monitoring application on the virtual appliance comprises:
upgrading a hardware configuration of the virtual appliance that runs the first remote collector based on a hardware requirement of the second remote collector; and
installing the second remote collector associated with the second monitoring application on the virtual appliance upon upgrading the operating system and the hardware configuration.

8. The method of claim 1, wherein configuring the connection information of the second remote collector comprises:
generating a one-time key during the installation of the second remote collector on the virtual appliance, wherein upon rebooting the virtual appliance, a secure communication is established between the second remote collector and the second monitoring application based on the one-time key.

9. A system comprising:
a data center comprising:
a first compute node; and
a second compute node to execute a first remote collector that communicates with the first compute node and a first monitoring application running on an on-premises server; and
a management node comprising instructions executable by a processing resource to:
upgrade a hardware configuration and an operating system of the second compute node;
install a second remote collector associated with a second monitoring application on the second compute node, the second monitoring application running on a cloud-based server;
configure connection information of the second remote collector to connect to the second monitoring application;
upgrade the first remote collector to the second remote collector using the upgraded hardware configuration, upgraded operating system, and the connection information; and
reboot the second compute node to enable the second remote collector to communicate with the first compute node and the second monitoring application.

10. The system of claim 9, wherein the second remote collector is to:
collect performance metrics of the operating system and/or applications associated with the first compute node in runtime; and
transmit, via a network, the performance metrics to the second monitoring application for monitoring and troubleshooting the first compute node.

11. The system of claim 9, wherein the processing resource is to:
deploy an operating system upgrade package associated with a second version of the operating system on the second compute node; and
upgrade the operating system of the second compute node from a first version that supports the first remote collector to the second version that supports the second remote collector according to the operating system upgrade package.

12. The system of claim 9, wherein the second remote collector acts as a cloud proxy for the first compute node to communicate with the second monitoring application running in the cloud-based server.

13. The system of claim 9, wherein the processing resource is to:
upon reboot of the second compute node, update configuration information of a monitoring agent running in the first compute node to communicate with the second remote collector to transmit the performance metrics and to receive a control command.

14. The system of claim 9, wherein the processing resource is to upgrade the first remote collector to the second remote collector by:
uninstalling and deleting an installation package associated with the first remote collector; and
installing an installation package associated with the second remote collector upon deleting the installation package associated with the first remote collector.

15. The system of claim 9, wherein the processing resource is to:
download a boot image and a boot program associated with the second remote collector to the second compute node; and
reboot the second compute node using the boot image and a boot program associated with the second remote collector.

16. A non-transitory machine-readable storage medium storing instructions executable by a processor of a management node to:
provision an additional storage resource to a virtual appliance that runs a first remote collector, wherein the first remote collector is to communicate with an endpoint and a first monitoring application running on an on-premises server;
upgrade an operating system of the virtual appliance;
install a second remote collector associated with a second monitoring application on the virtual appliance, wherein the second monitoring application is to run on a cloud-based server;
configure connection information of the second remote collector to connect to the second monitoring application;
transform the first remote collector to the second remote collector using the additional storage resource, upgraded operating system, and the connection information; and
prompt a reboot the virtual appliance to enable the second remote collector to communicate with the endpoint and the second monitoring application.

17. The non-transitory machine-readable storage medium of claim 16, wherein instructions to transform the first remote collector to the second remote collector comprise instructions to:
uninstall and delete an installation package associated with the first remote collector from the virtual appliance; and
install an installation package associated with the second remote collector on the virtual appliance upon deleting the installation package associated with the first remote collector.

18. The non-transitory machine-readable storage medium of claim 16, wherein the second remote collector acts as a cloud proxy for the endpoint to communicate with the second monitoring application running in the cloud-based server.

19. The non-transitory machine-readable storage medium of claim 16, further comprising instructions to:
upon reboot of the virtual appliance, update configuration information of a monitoring agent running in the virtual appliance to communicate with the second remote collector to transmit the performance metrics and to receive a control command.

20. The non-transitory machine-readable storage medium of claim 16, wherein the endpoint comprises a physical host computing system, a virtual machine, a container, or a software defined data center (SDDC).
